(19) United States
(12) Patent Application Publication
(10) Pub. No.: US 2015/0112537 A1
(43) Pub. Date: Apr. 23, 2015

(54) NAVIGATION SYSTEM FOR AUTONOMOUS DUMP TRUCKS

(71) Applicant: HITACHI CONSTRUCTION MACHINERY CO., LTD., Tokyo (JP)

(72) Inventors: Yukihiro KAWAMATA, Tokyo (JP); Hiroto MORIZANE, Tokyo (JP); Tomoyuki HAMADA, Tsuchiura (JP); Hidefumi ISHIMOTO, Tsuchiura (JP)

(21) Appl. No.: 14/519,397

(22) Filed: Oct. 21, 2014

(30) Foreign Application Priority Data
Oct. 22, 2013 (JP) 2013-219504

(51) Int. Cl. G01C 21/34

(52) U.S. Cl. CPC G01C 21/34
USPC 701/23

(57) ABSTRACT

Provided is a navigation system for autonomous dump trucks capable of preventing a dump truck from autonomously traveling on a carrying passage differing from the actual carrying passage even when the carrying passages for the dump truck have been altered. The navigation system is based on map data created by digitizing a map of roads on which the dump truck can travel. A control unit executes switching control between an autonomous mode to be selected when the autonomous traveling of the dump truck should be performed and a maneuver mode to be selected when the dump truck should travel according to an operator, based on version information of the map data used by the dump truck for the autonomous traveling and version information of master map data created by digitizing a map of the latest roads on which the dump truck can travel, managed by a control center.

### BACKGROUND OF THE INVENTION

1. Field of the Invention

The present invention relates to a navigation system for autonomous dump trucks.

2. Description of the Related Art

In a navigation system for autonomous dump trucks, the autonomous traveling of a dump truck is carried out based on a host vehicle position (position of the vehicle itself) which is determined by a position measurement device (e.g., GPS (Global Positioning System)) installed in the dump truck and map data which has been created by digitizing a map of roads on which the dump truck can travel.

Among the autonomous traveling systems of this kind, there is a system that allows an operator to properly select an autonomous mode (to be selected when the autonomous traveling should be performed by a, mining dump truck (extra-large dump truck)) or a different mode (to be selected when the autonomous traveling should not be performed by the mining dump truck) in order to achieve appropriate switching between the execution and the stoppage of the autonomous traveling depending on the situation (see U.S. Pat. No. 5,646,843, for example). Examples of the aforementioned “different mode” include a “passenger maneuver mode” in which an operator actually gets in the mining dump truck and performs the steering and the speed control and a “remote maneuver mode” in which an operator performs the steering and the speed control of the mining dump truck by means of remote control.

### SUMMARY OF THE INVENTION

Especially in mining sites in mines, alteration (extension, addition, disuse, temporary closure, etc.) of roads on which the mining dump truck can travel (carrying passages) occurs frequently with the progress of the mining operation. With such frequent alteration of the carrying passages, the probability of the occurrence of unconformity increases between the carrying passages in the map data that is referred to at the time of the autonomous traveling and the latest carrying passages on which the mining dump truck can actually travel at that point of time. Thus, there is a danger that old map data (referred to at the time of the autonomous traveling) causes the mining dump truck to erroneously travel on a carrying passage that existed in the map data but does not actually exist at the time of the autonomous traveling, for example.

It is therefore the primary object of the present invention to provide a navigation system for autonomous dump trucks capable of preventing a dump truck from autonomously traveling on a carrying passage differing from the actual carrying passage even when the carrying passages for the dump truck have been altered.

To achieve the above object, a navigation system for autonomous dump trucks in accordance with an aspect of the present invention comprises: a dump truck which is capable of traveling autonomously based on map data created by digitizing a map of roads on which the dump truck can travel; and a control unit which executes switching control between an autonomous mode to be selected when the autonomous traveling of the dump truck should be performed and a different mode to be selected when the autonomous traveling of the dump truck should be interrupted, based on version information on the map data used by the dump truck for the autonomous traveling and version information on master map data created by digitizing a map of the latest roads on which the dump truck can travel.

According to the present invention, it is possible to make the dump truck perform the autonomous traveling according to the latest road map. Therefore, autonomously traveling of the dump truck according to an old road map can be prevented.

### BRIEF DESCRIPTION OF THE DRAWINGS

FIG. 1 is a schematic diagram showing state transitions in regard to traveling mode switching in embodiments of the present invention.

FIG. 2 is a conceptual diagram of the present invention.

FIG. 3 is a block diagram showing a system configuration employed in a first embodiment of the present invention.

FIG. 4 is a flow chart of a process executed by an in-vehicle terminal system according to the first embodiment.

FIG. 5 is a flow chart of a process executed by a control center system according to the first embodiment.

FIG. 6 is an explanatory drawing in regard to versions of map data.

FIG. 7 is a schematic diagram showing a screen for receiving a switching request for the switching between an autonomous mode and a maneuver mode.

FIG. 8 is a schematic diagram showing a screen for informing the operator of the switching to the autonomous mode.

FIG. 9 is a schematic diagram showing a screen for informing the operator that the map is old.

FIG. 10 is a schematic diagram showing a screen for informing the operator of the switching to the maneuver mode.

FIG. 11 is a schematic diagram showing an example of a case where an operator screen is displayed on an in-vehicle monitor of a mining dump truck.

FIG. 12 is a schematic diagram showing an example of a case where an operator screen is displayed on a remote control terminal.

FIG. 13 is a block diagram showing a system configuration employed in a second embodiment of the present invention.

FIG. 14 is a flow chart of a process executed by an in-vehicle terminal system according to the second embodiment.

FIG. 15 is a flow chart of a process executed by a control center system according to the second embodiment.

FIG. 16 is a schematic diagram showing an example of a map update confirmation screen.

FIG. 17 is a schematic diagram showing an example of a map update completion screen.

FIG. 18 is a schematic diagram showing how a USB flash memory for map update is used (inserted).

FIG. 19 is a block diagram showing a system configuration employed in a third embodiment of the present invention.

FIG. 20 is a flow chart of a process executed by an in-vehicle terminal system according to the third embodiment.

FIG. 21 is a schematic diagram showing an example of a map update confirmation screen in which an autonomous mode button has been inactivated.

FIG. 22 is a schematic diagram showing an example of a map update completion screen in which the autonomous mode button has been activated.

FIG. 23 is a flow chart of a process executed by an in-vehicle terminal system according to a fourth embodiment of the present invention.

### DESCRIPTION OF THE PREFERRED EMBODIMENTS

In navigation systems for autonomous dump trucks which will be described below as embodiments of the present invention, switching between an autonomous mode (as a traveling mode which is selected when the autonomous traveling should be performed by a mining dump truck) and a different traveling mode (other than the autonomous mode) is controlled after checking freshness of map data which is used when the mining dump truck performs the autonomous traveling. In this embodiment, the freshness of the map data is checked based on version information included in the map data. While concrete examples will be explained later, the “version information” in this description basically means update history information on the map data. For example, a time stamp indicating the time when the map data was stored in a storage device, a storage medium or the like, characters/symbols indicating the version of the map data, etc. can be used as the version information.

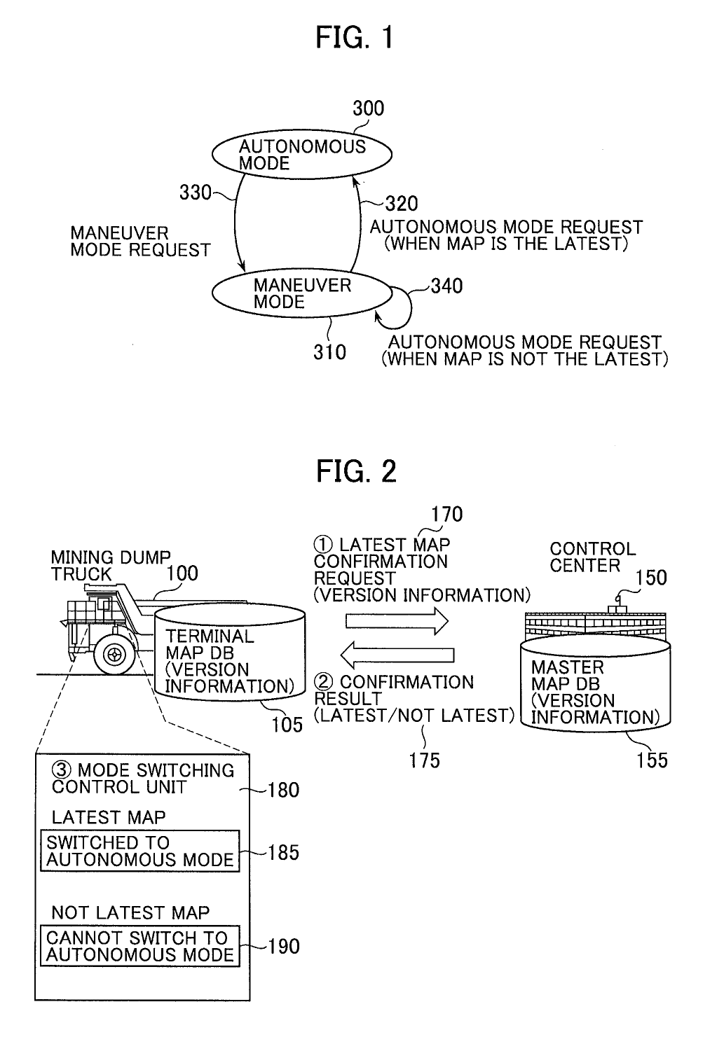

FIG. 1 is a schematic diagram showing state transitions in regard to the traveling mode switching in the embodiments of the present invention. As shown in FIG. 1, the autonomous traveling system in accordance with each embodiment of the present invention has an autonomous mode 300 and a maneuver mode 310 as the traveling modes of the mining dump truck. The autonomous traveling system is configured so that the switching between the two modes 300 and 310 is possible.

The maneuver mode 310 is a mode in which an operator actually gets in the mining dump truck and steers and accelerates/decelerates the mining dump truck by performing the steering operation, the accelerator operation and the brake operation. The autonomous mode 300 is a mode in which autonomous traveling control for having the vehicle (mining dump truck) autonomously steer and accelerate/decelerate is performed in accordance with commands from a control center system. In the maneuver mode 310, it is also possible to prepare a mode in which an operator operates the mining dump truck by means of remote control (remote maneuver mode) in addition to or in place of the aforementioned mode in which an operator actually gets in and operates the mining dump truck (passenger maneuver mode). While the autonomous traveling system in each embodiment is configured to enable the mode switching between the autonomous mode 300 and the maneuver mode 310, the autonomous traveling system may also be configured to enable mode switching between the autonomous mode 300 and a different mode (other than the maneuver mode 310) as long as the mode is a mode to be selected when the autonomous traveling of the mining dump truck should be interrupted or prohibited. As an example of such a mode other than the maneuver mode 310, an emergency stop mode to be selected when a worker in the vicinity of the mining dump truck urgently stops the dump truck can be employed, for example. The emergency stop mode is selected in response to an emergency stop command which is issued by pressing an emergency stop button arranged on the exterior surface of the mining dump truck or on a remote control unit, for example.

As shown in FIG. 1, when a switching request for the switching to the maneuver mode 310 (maneuver mode request) is issued when the autonomous mode 300 has been selected, transition from the autonomous mode 300 to the maneuver mode 310 is carried out as indicated by the arrow 330. On the other hand, when a switching request for the switching to the autonomous mode 300 (autonomous mode request) is issued when the maneuver mode 310 has been selected, mode transition indicated by the arrow 320 is carried out only if the map data used by the mining dump truck is the latest data. If the map data used by the mining dump truck is not the latest, the traveling mode is kept in the maneuver mode 310 (with no transition to the autonomous mode 300) as indicated by the arrow 340 irrespective of the issuance of the autonomous mode request. As above, according to the present invention, the autonomous traveling is performed only when the map held by the mining dump truck is the latest map. Therefore, the trouble caused by the unconformity between the carrying passages specified by the map data and the actual carrying passages can be prevented.

Next, a conceptual diagram of the present invention is shown in FIG. 2. As shown in FIG. 2, the navigation system for autonomous mining dump trucks in accordance with the present invention comprises a mining dump truck 100 and a control center 150. The mining dump truck 100 is equipped with a terminal map DB (database) 105 in which terminal map data (created by digitizing a map of roads (carrying passages) in a mine on which the mining dump truck can travel) is stored and managed. The control center 150 is equipped with a master map DB 155 in which master map data (created by digitizing a map of the latest carrying passages in the mine) is stored and managed. Incidentally, the “latest” in the expression “latest carrying passages” means that the carrying passages are the latest in the sense that the carrying passages coincide with those on a road map for management that is used in the control center 150 at that point of time. Thus, the master map data is not required to incorporate and reflect the alteration of the actual carrying passages in real time. Therefore, even when a part of an actual carrying passage is being extended from hour to hour, carrying passages in map data can still be regarded as the “latest” (even if the road being extended has not been incorporated into the map data) if the road being extended has not been incorporated into the map in the control center 150, as long as the map data coincides with the map in the control center 150.

In the example shown in FIG. 2, a latest map confirmation request 170 for confirming whether the map data stored in the terminal map DB 105 is the latest or not is transmitted from the mining dump truck 100 to the control center 150 at the startup of the mining dump truck 100, for example. The latest map confirmation request 170 includes version information on the map data managed in the terminal map DB 105. Thus, the version information on the map data of the mining dump truck 100 is transmitted to the control center 150 together with the confirmation request 170.

Subsequently, the control center 150 judges whether the map data in the terminal map DB 105 is the latest or not based on the version information on the map data managed in the terminal map DB 105 and the version information on the map data managed in the master map DB 155. The control center 150 transmits a confirmation result 175 (indicating whether the map data managed in the terminal map DB 105 is the latest or not) to the mining dump truck 100.

A mode switching control unit 180 installed in the mining dump truck 100 performs the switching control between the autonomous mode 300 and the maneuver mode 310 according to the confirmation result 175. In this control, the transition to the autonomous mode is permitted when the confirmation result 175 indicates that the map data in the terminal map DB 105 is the latest (reference character “185” in FIG. 2). In contrast, when the confirmation result 175 indicates that the map data in the terminal map DB 105 is not the latest, the transition to the autonomous mode is not permitted (reference character “190” in FIG. 2). In the following, embodiments of the navigation system for autonomous dump trucks in accordance with the present invention will be described in detail.

### First Embodiment

First, a description will be given below of a first embodiment of the present invention. The first embodiment is an example of a navigation system for autonomous mining dump trucks in which whether the map data held by the mining dump truck is of the latest version or not is confirmed at the startup of the mining dump truck and the mode switching to the autonomous mode is carried out after the confirmation. In the first embodiment, when the map data held by the mining dump truck is not the latest, the transition to the autonomous mode is prohibited, by which the mining dump truck is prevented from erroneously traveling on a carrying passage not in conformity with the actual carrying passages. Further, the reason why the autonomous traveling is impossible (i.e., because of the old map data) is presented to the operator.

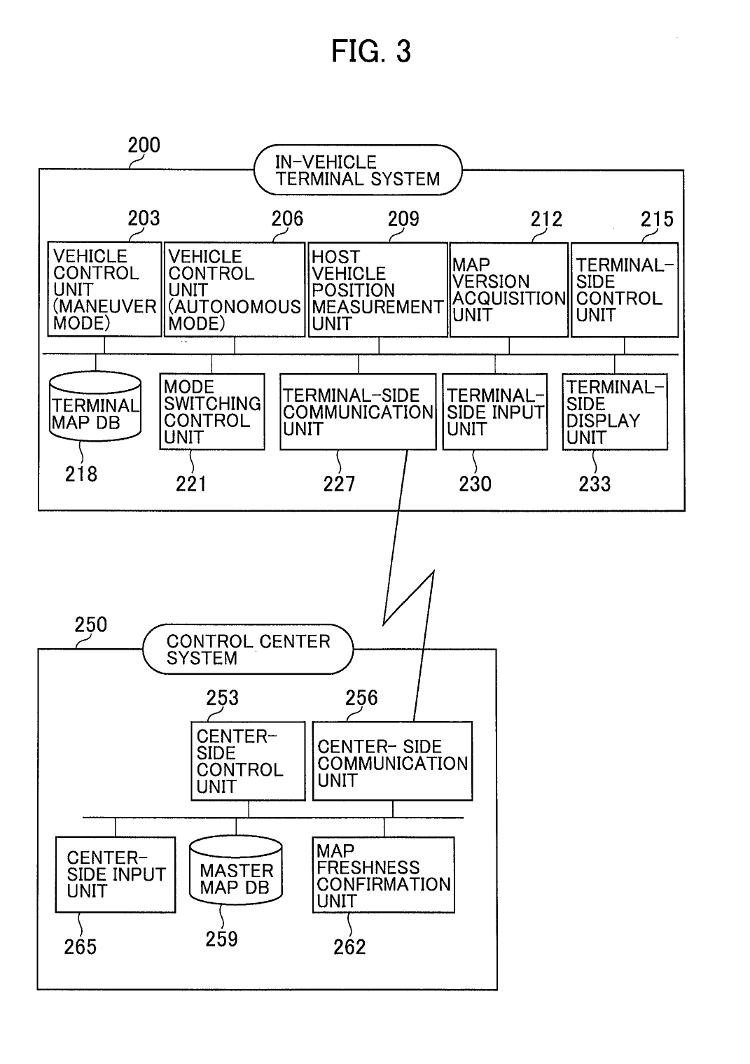

FIG. 3 is a block diagram showing a system configuration employed in the first embodiment of the present invention. The autonomous traveling system according to the first embodiment comprises an in-vehicle terminal system 200 which is installed in the mining dump truck and a control center system 250 which is connected with the in-vehicle terminal system 200 via wireless communication devices in order to manage the mining dump truck.

The in-vehicle terminal system 200 includes a host vehicle position measurement unit 209, a terminal map DB (map data storage unit) 218, an in-vehicle control unit (maneuver mode) 203, an in-vehicle control unit (autonomous mode) 206, a map version acquisition unit 212, a mode switching control unit 221, a terminal-side communication unit 227, a terminal-side input unit 230, a terminal-side display unit 233, and a terminal-side control unit 215. The host vehicle position measurement unit 209 measures the host vehicle position (position of the vehicle itself) by using a GPS sensor, a gyro sensor, an acceleration sensor, etc. The terminal map DB 218 (map data storage unit) stores and manages the map data which is used by the in-vehicle terminal system 200 when the autonomous mode is selected. The vehicle control unit (maneuver mode) 203 performs the traveling control on the vehicle according to the steering operation, the accelerator operation and the brake operation by the operator. The vehicle control unit (autonomous mode) 206 performs control for making the vehicle travel autonomously according to the map data in the terminal map DB 218 (autonomous traveling control) based on the host vehicle position measured by the host vehicle position measurement unit 209, the map data in the terminal map DB 218, commands sent from the control center system 250, etc. The map version acquisition unit 212 executes a process of acquiring the version information on the map data held by the terminal map DB 218. The mode switching control unit 221 performs the switching control between the autonomous mode and the maneuver mode based on the version information on the map data in the terminal map DB 218 and the version information on the master map data in a master map DB 259 (explained later). The terminal-side communication unit 227 functions as a communication interface for the communication with the control center system 250. The terminal-side input unit 230 functions as an input interface for receiving inputs from an operator in the in-vehicle terminal system 200. The terminal-side display unit 233 functions as an output interface for displaying information to the operator in the in-vehicle terminal system 200. The terminal-side control unit 215 controls various processing flows executed by the in-vehicle terminal system 200.

The control center system 250 includes a master map DB (master map storage unit) 259, a map freshness confirmation unit 262, a center-side communication unit 256, a center-side control unit 253, and a center-side input unit 265. The master map DB (master map storage unit) 259 stores and manages the master map data as map data into which the latest carrying passages for the mining dump truck have been incorporated. The map freshness confirmation unit 262 confirms whether the map data in the in-vehicle terminal system 200 is the latest or not by comparing the version information on the master map data managed by the master map DB 259 with the version information on the map data held by the in-vehicle terminal system 200. The center-side communication unit 256 functions as a communication interface for the communication with the terminal-side communication unit 227 of the in-vehicle terminal system 200. The center-side control unit 253 controls various processing flows executed by the control center system 250. The center-side input unit 265 functions as an input interface for receiving inputs (e.g., command for starting/ending the processing in the control center system 250) from an operator.

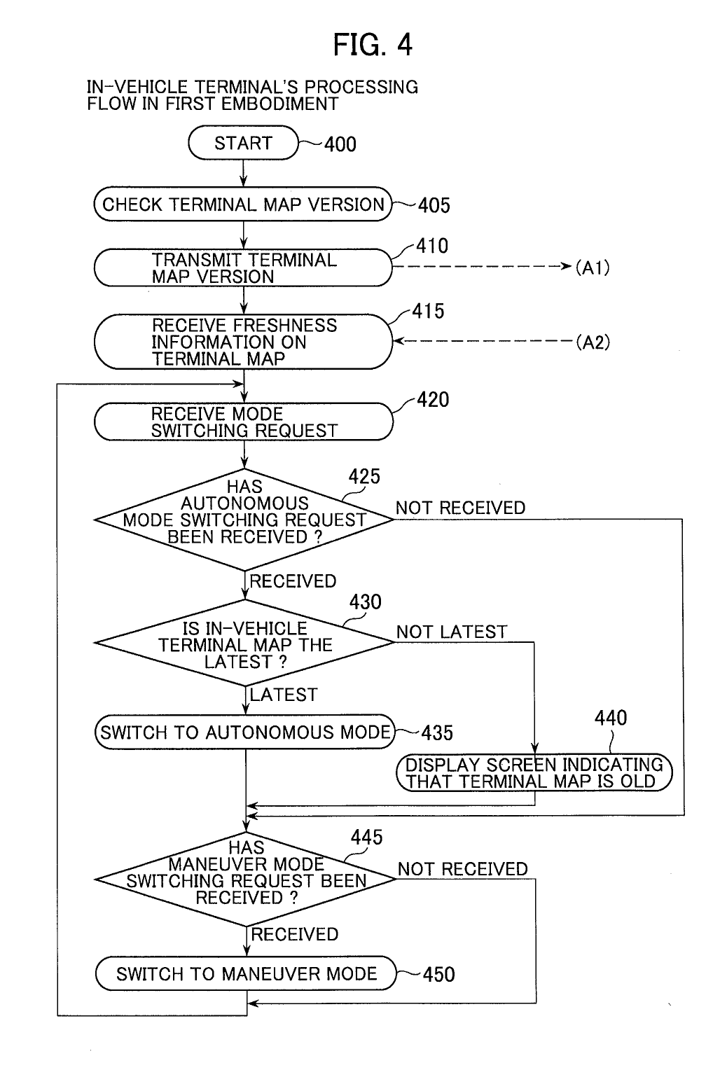

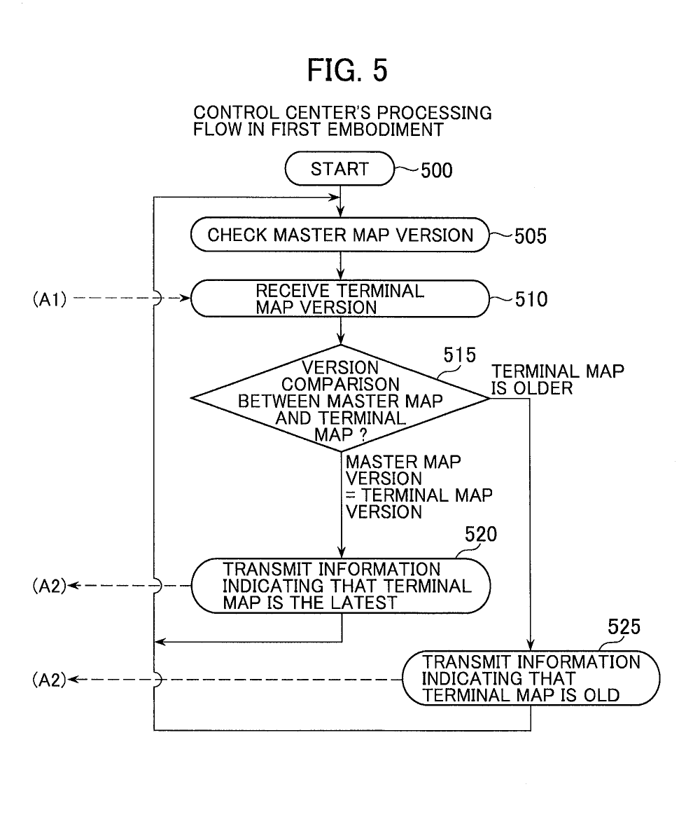

FIG. 4 is a flow chart of a process executed by the in-vehicle terminal system 200 according to the first embodiment. FIG. 5 is a flow chart of a process executed by the control center system 250 according to the first embodiment.

Referring to FIG. 4, the in-vehicle terminal system 200 first executes an initial setting process (receiving a processing start request from a user, checking whether the mining dump truck's engine is ON or not, and so forth) in step 400. When the user's request for starting up the autonomous traveling system is inputted via the terminal-side input unit 230, the autonomous traveling system is started up and the process advances to step 405.

In the step 405, the map version acquisition unit 212 acquires the version information on the map data managed by the terminal map DB 218.

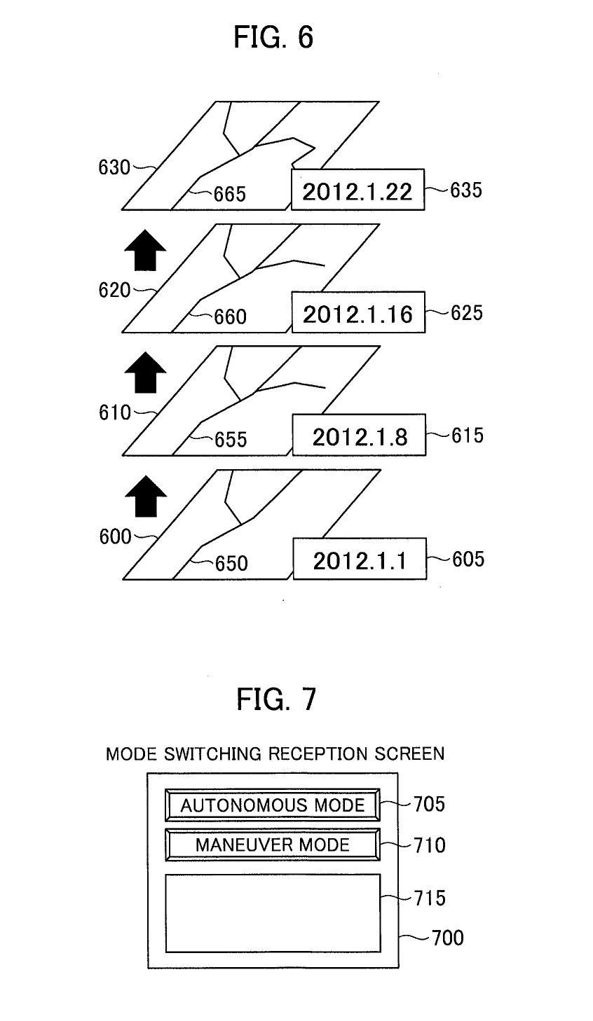

Here, the freshness of map data managed by the terminal map DB 218 and the master map DB 259 will be explained by referring to FIG. 6. The freshness of map data represents the newness of the version of the map data. In the example of FIG. 6, a plurality of maps 600, 610, 620 and 630 of the same place that have been created in different periods are shown.

In the map 600, a carrying passage 650 for the mining dump truck as an unbranched road is drawn. The map 600 is a map created on Jan. 1, 2012. The version information 605 on the map 600 is managed by use of information “2012.1.1” as a numeral string representing the date (year, month, day) of the creation of the map.

The map 610 is a map created on Jan. 8, 2012 (7 days newer than the map 600). In the map 610, carrying passages 655 formed by adding a fork road (branched road) to the carrying passage 650 in the most recent map 600 are drawn. Similarly to the map 600, the version information 615 on the map 610 is managed by use of a numeral string (2012.1.8) representing the map creation date (year, month, day).

The map 620 is a map created on Jan. 16, 2012 (8 days newer than the map 610). In the map 620, carrying passages 660 formed by further adding a fork road to the carrying passages 655 in the most recent map 610 are drawn. The version information 625 on the map 620 is also managed by use of a numeral string (2012.1.16) representing the map creation date (year, month, day).

The map 630 is a map created on Jan. 22, 2012 (6 days newer than the map 620). In the map 630, carrying passages 665 formed by extending a fork road in the most recent map 620 are drawn. The version information 635 on the map 630 is also managed by use of a numeral string (2012.1.22) representing the map creation date (year, month, day).

Incidentally, while a case where the carrying passages are gradually increased as the map version approaches the latest version is described in this example, there are also cases where part of the carrying passages in the map of the most recent version is deleted in the version upgrade. While all the carrying passages in the mine on which the mining dump truck can travel are included in the map data in this example, it is also possible to previously extract carrying passages related to a travel route of the mining dump truck from all the carrying passages and create map data of the extracted carrying passages. While the map creation date (year, month, day) is used as the version information in the above example, the version information may also be described by using the time of the creation of the map data (map creation time) together with the map creation date (year, month, day), by using characters and/or symbols representing the version of the map data instead of the map creation date, and so forth. Thus, the version may be defined in any style as long as the recognition of the version of each piece of map data and the comparison between versions are possible.

Returning to FIG. 4, in step 410, the version of the map data in the in-vehicle terminal system 200 acquired by the map version acquisition unit 212 in the step 405 is transmitted to the center-side communication unit 256 of the control center system 250 via the terminal-side communication unit 227.

As shown in FIG. 5, the control center system 250 executes an initial setting process (e.g., receiving a processing start request from a user) in step 500 and then advances to step 505. The processing start request from the user is inputted via the center-side input unit 265.

In the step 505, the map freshness confirmation unit 262 acquires the version of the master map data managed by the master map DB 259 (i.e., the version of the latest map data). Thereafter, the process advances to step 510.

In the step 510, the version of the map data in the in-vehicle terminal system 200 transmitted from the terminal-side communication unit 227 in the step 410 is received by the center-side communication unit 256. Thereafter, the process advances to step 515.

In the step 515, the map freshness confirmation unit 262 compares the version of the master map data acquired in the step 505 with the version of the map data held by the in-vehicle terminal system 200 received in the step 510. If the version of the map data held by the in-vehicle terminal system 200 is the same as that of the master map data (i.e., if the map data is the latest map data), the process advances to step 520. In contrast, if the version of the map data held by the in-vehicle terminal system 200 is older than that of the master map data (i.e., if the map data is not the latest map data), the process advances to step 525.

In the step 520, freshness information indicating that the map data held by the in-vehicle terminal system 200 is the latest is transmitted from the center-side communication unit 256 to the terminal-side communication unit 227 of the in-vehicle terminal system 200. Thereafter, the process returns to the step 505.

In the step 525, freshness information indicating that the map data held by the in-vehicle terminal system 200 is old is transmitted from the center-side communication unit 256 to the terminal-side communication unit 227 of the in-vehicle terminal system 200. Thereafter, the process returns to the step 505.

Returning to FIG. 4, in step 415, the freshness information transmitted from the control center system 250 in the step 520 (freshness information indicating that the map data held by the in-vehicle terminal system 200 is the latest) or in the step 525 (freshness information indicating that the map data held by the in-vehicle terminal system 200 is old) is received by the terminal-side communication unit 227 of the in-vehicle terminal system 200. Thereafter, the process advances to step 420.

In the step 420, an autonomous mode switching request or a maneuver mode switching request from the operator is received by the terminal-side input unit 230. Thereafter, the process advances to step 425. The reception of the mode switching request from the operator in the step 420 will be explained here by referring to FIG. 7.

FIG. 7 is a schematic diagram showing a screen (screen 700 for receiving the autonomous mode switching request or the maneuver mode switching request) displayed on the terminal-side display unit 233. Arranged on the screen 700 are an autonomous mode button 705 to be pressed for selecting the autonomous mode, a maneuver mode button 710 to be pressed for selecting the maneuver mode, and a mode switching information window 715 for displaying information regarding the mode switching. It is assumed in this example that the terminal-side display unit 233 is implemented by a touch panel, the mode switching is possible by touching (pressing) the button 705 or 710 on the screen, and the mode selected by the operator is judged by having the terminal-side input unit 230 detect the pressed state of the autonomous mode button 705 or the maneuver mode button 710.

Returning to FIG. 4, in the step 425, the terminal-side control unit 215 judges whether the autonomous mode switching request (mode switching request for the switching to the autonomous mode) has been received or not. If received, the process advances to step 430. If not received, the process advances to step 445.

In the step 430, the mode switching control unit 221 checks whether or not the freshness information received in the step 415 indicates that the map data is the latest. If the freshness information indicates that the map data is the latest, the mode switching control unit 221 permits the switching to the autonomous mode and advances to step 435. If not the latest (old map), the mode switching control unit 221 does not permit the switching to the autonomous mode. In this case, the process advances to step 440.

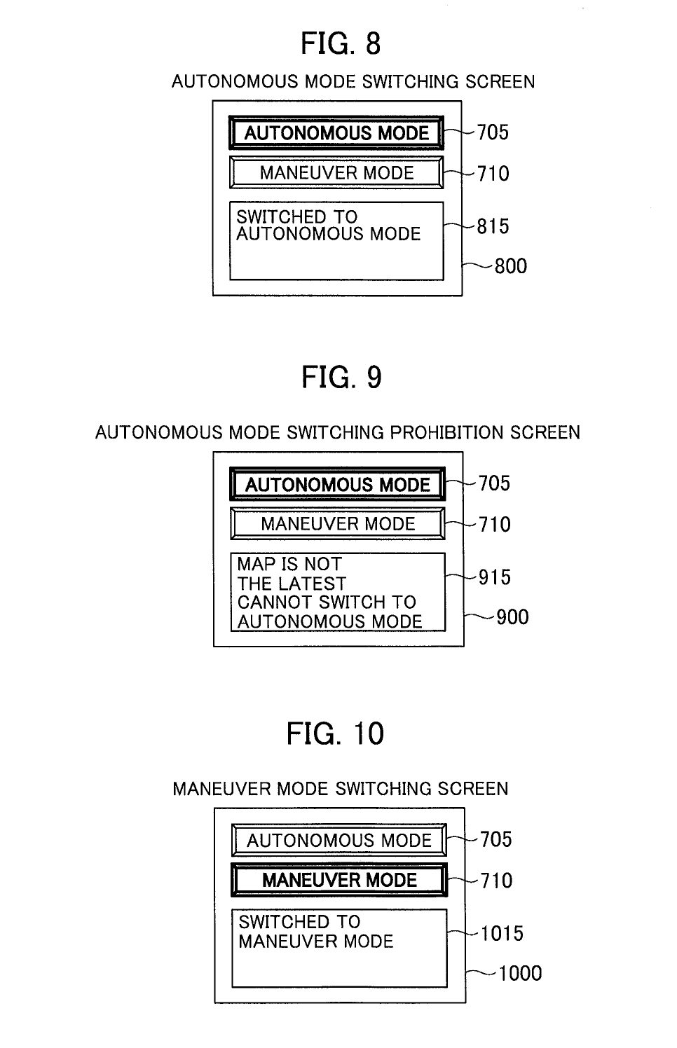

In the step 435, the mode switching control unit 221 executes a switching process from the maneuver mode to the autonomous mode. In this switching process, the control is switched from the control by the vehicle control unit (maneuver mode) 203 (controlling the vehicle according to the operation by the operator) to the control by the vehicle control unit (autonomous mode) 206 (performing the autonomous traveling control of autonomously steering and accelerating/decelerating the vehicle according to commands from the control center system 250). Thereafter, the process advances to step 445. Here, a screen for informing the operator that the switching to the autonomous mode has been performed in the step 435 is shown in FIG. 8.

FIG. 8 is a schematic diagram showing a screen 800 for informing the operator of the switching to the autonomous mode. The screen 800 is displayed on the terminal-side display unit 233. On the screen 800, a message “SWITCHED TO AUTONOMOUS MODE” is displayed in a mode switching information window 815. This display lets the operator recognize that the traveling mode of the mining dump truck has been switched to the autonomous mode.

Returning to FIG. 4, in the step 440, the terminal-side display unit 233 displays to the operator that the map held by the in-vehicle terminal system 200 is old. Thereafter, the process advances to the step 445. Here, a screen for informing the operator that the map is old in the step 440 is shown in FIG. 9.

FIG. 9 is a schematic diagram showing a screen 900 for informing the operator that the map is old. The screen 900 is displayed on the terminal-side display unit 233. On the screen 900, messages “MAP IS NOT THE LATEST” and “CANNOT SWITCH TO AUTONOMOUS MODE” are displayed in a mode switching information window 915. This display lets the operator recognize that the switching to the autonomous mode is impossible because of the old map held by the in-vehicle terminal system 200.

Returning to FIG. 4, in the step 445, the terminal-side control unit 215 judges whether the maneuver mode switching request (mode switching request for the switching to the maneuver mode) has been received or not. If received, the process advances to step 450. If not received, the process returns to the step 420.

In the step 450, the mode switching control unit 221 executes a switching process from the autonomous mode to the maneuver mode. In this switching process, the control is switched from the control by the vehicle control unit (autonomous mode) 206 (performing the autonomous traveling control of autonomously steering and accelerating/decelerating the vehicle according to commands from the control center system 250) to the control by the vehicle control unit (maneuver mode) 203 (controlling the vehicle according to the operation by the operator). Thereafter, the process returns to the step 420. Here, a screen for informing the operator that the switching to the maneuver mode has been performed in the step 450 is shown in FIG. 10.

FIG. 10 is a schematic diagram showing a screen 1000 for informing the operator of the switching to the maneuver mode. The screen 1000 is displayed on the terminal-side display unit 233. On the screen 1000, a message “SWITCHED TO MANEUVER MODE” is displayed in a mode switching information window 1015. This display lets the operator recognize that the traveling mode of the mining dump truck has been switched to the maneuver mode.

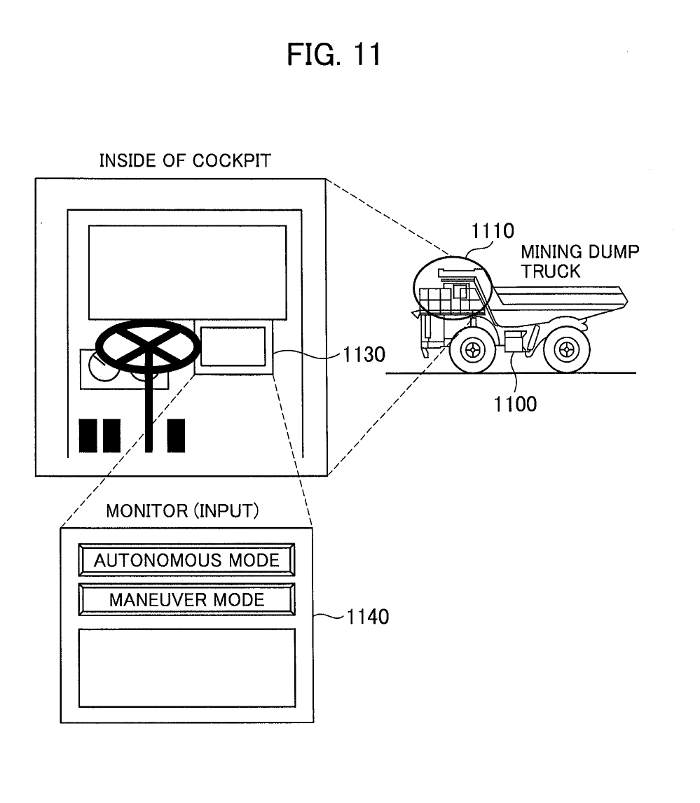

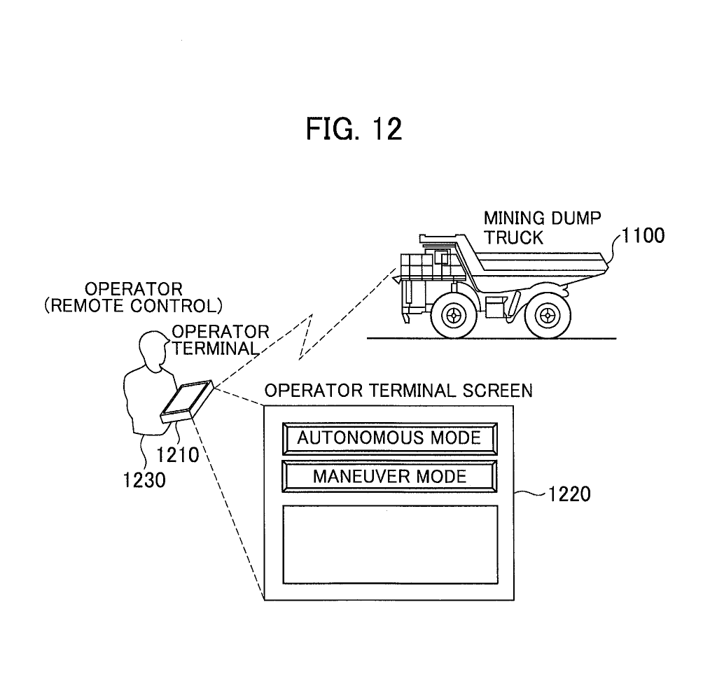

Incidentally, the aforementioned screens (input screen, information display screen) shown in FIGS. 7, 8, 9 and 10 may also be displayed on an in-vehicle monitor in the cockpit of the mining dump truck or a mobile terminal of the operator instead of displaying the screens on the terminal-side display unit 233. Examples of the display in this case will be explained below referring to FIGS. 11 and 12. FIG. 11 is a schematic diagram showing an example of a case where a screen 1140 is displayed on an in-vehicle monitor 1130 in the cockpit 1110 of a mining dump truck 1100. FIG. 12 is a schematic diagram showing an example of a case where a screen 1220 is displayed on an operator terminal 1210 which is operated for remote control by an operator 1230 at a place distant from a mining dump truck 1100. In the example where the screen 1140 is displayed in the cockpit (FIG. 11), the operator can get in the mining dump truck and perform the switching operation for the mode switching to the autonomous mode or the maneuver mode during maintenance or mechanical failure. In the example of remote control (FIG. 12), the autonomous traveling of the mining dump truck can be commanded safely and correctly from a distant place.

According to the first embodiment configured as above, the transition from the maneuver mode to the autonomous mode is permitted only when the version information on the map data in the terminal map DB 218 coincides with the version information on the master map data in the master map DB 259 (i.e., only when the map data held by the mining dump truck is the latest). When the version information on the map data in the terminal map DB 218 does not coincide with the version information on the master map data in the master map DB 259 (i.e., when the map data held by the mining dump truck is not the latest), the transition from the maneuver mode to the autonomous mode is prohibited, by which the mining dump truck is prevented from erroneously traveling on an old carrying passage not in conformity with the latest carrying passages. This contributes to the prevention of accidents. Further, it is possible to prompt the operator to update the map to enable the autonomous traveling since the reason why the autonomous traveling mode cannot be carried out (because of the old map data) is presented to the operator.

### Second Embodiment

Next, a second embodiment of the present invention will be described. The second embodiment is an example of a navigation system for autonomous mining dump trucks in which the freshness of the map data is checked upon receiving the autonomous mode switching request (mode switching request for the switching to the autonomous mode) and the traveling mode is switched to the autonomous mode after updating the map data in cases where the map data is not the latest. In the second embodiment, when the map data of the mining dump truck is not the latest, the operator is prompted to update the map (map data). The switching to the autonomous mode is carried out after updating the map to achieve the map conformity with the actual carrying passages.

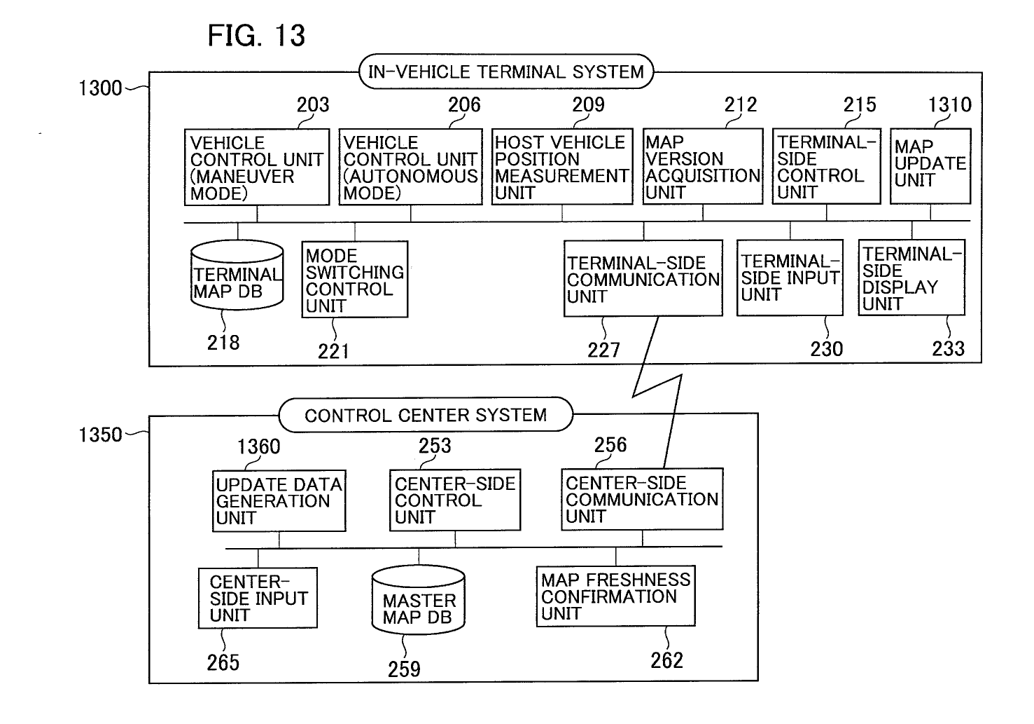

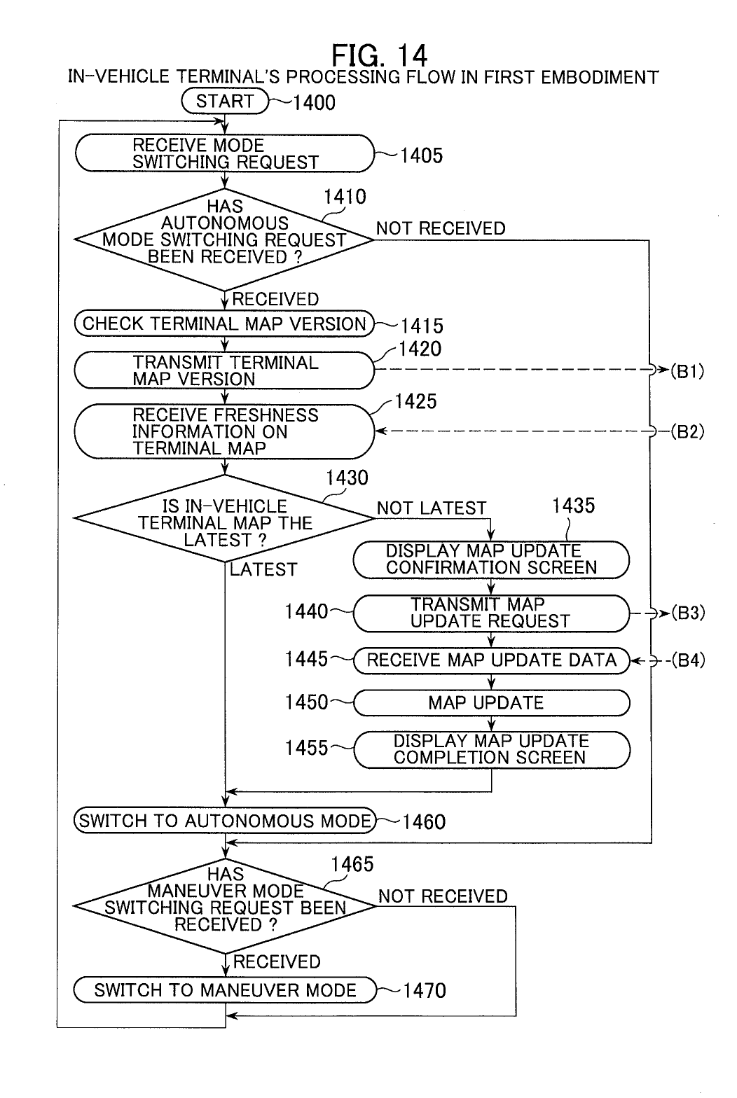

FIG. 13 is a block diagram showing a system configuration employed in the second embodiment of the present invention. Similarly to the system in the first embodiment, the autonomous traveling system according to the second embodiment comprises an in-vehicle terminal system 1300 which is installed in the mining dump truck and a control center system 1350 which is connected with the in-vehicle terminal system 1300 via wireless communication devices in order to manage the mining dump truck. The in-vehicle terminal system 1300 corresponds to a system implemented by adding a map update unit 1310 to the in-vehicle terminal system 200 in the first embodiment. The control center system 1350 corresponds to a system implemented by adding an update data generation unit 1360 to the control center system 250 in the first embodiment. Components equivalent to those shown in FIG. 3 are assigned the already used reference characters and repeated explanation thereof is omitted properly.

The update data generation unit 1360 in the control center system 1350 is a part for executing a process of generating update data for updating the map data held by the terminal map DB 218 to the same version as the latest map data held by the master map DB 259. The map update unit 1310 in the in-vehicle terminal system 1300 is a part for executing a process of updating the map data in the terminal map DB 218 to the latest state by using the update data generated and supplied by the update data generation unit 1360 of the control center system 1350.

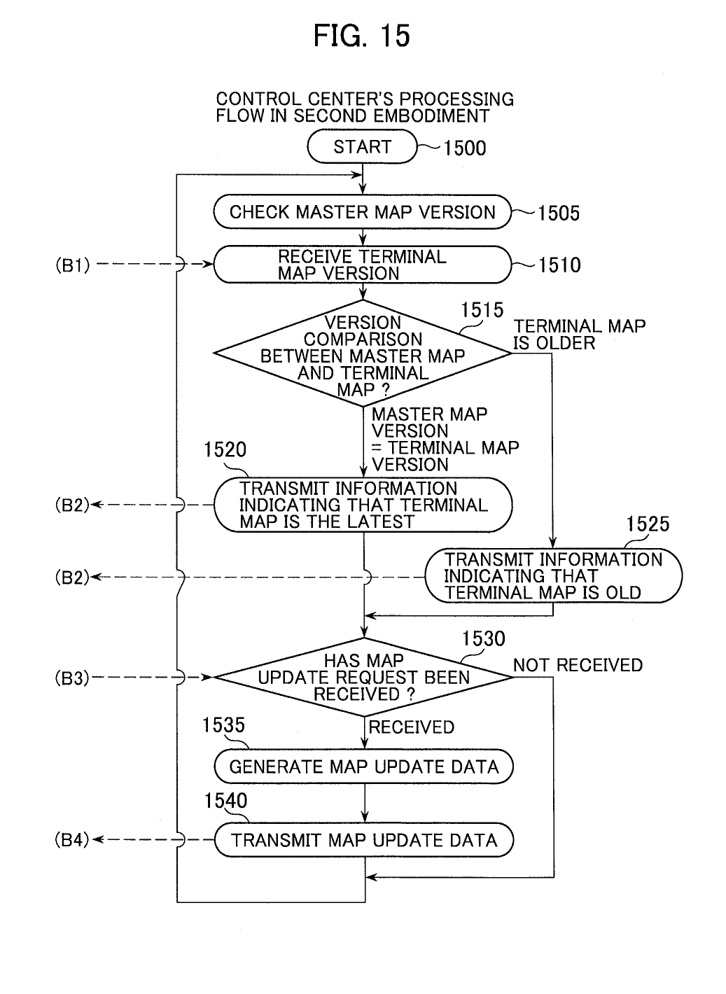

FIG. 14 is a flow chart of a process executed by the in-vehicle terminal system 1300 according to the second embodiment. FIG. 15 is a flow chart of a process executed by the control center system 1350 according to the second embodiment.

Referring to FIG. 14, the in-vehicle terminal system 1300 first executes the initial setting process (receiving the processing start request from a user, checking whether the mining dump truck's engine is ON or not, and so forth) in step 1400. The processing start request from the user is inputted via the terminal-side input unit 230.

In step 1405, the autonomous mode switching request or the maneuver mode switching request from the operator is received by the terminal-side input unit 230. Thereafter, the process advances to step 1410. The mode switching request from the operator is received by use of the screen 700 shown in FIG. 7 similarly to the first embodiment.

In the step 1410, the terminal-side control unit 215 judges whether the autonomous mode switching request has been received or not. If received, the process advances to step 1415. If not received, the process advances to step 1465.

In the step 1415, the map version acquisition unit 212 acquires the version of the map data managed by the terminal map DB 218. Thereafter, the process advances to step 1420.

In the step 1420, the version acquired by the map version acquisition unit 212 in the step 1415 (version of the map data held by the in-vehicle terminal system 1300) is transmitted from the terminal-side communication unit 227 to the center-side communication unit 256 of the control center system 1350.

As shown in FIG. 15, the control center system 1350 executes the initial setting process (e.g., receiving the processing start request from a user) in step 1500 and then advances to step 1505. The processing start request from the user is inputted via the center-side input unit 265.

In the step 1505, the map freshness confirmation unit 262 acquires the version of the master map data managed by the master map DB 259 (i.e., the version of the latest map data). Thereafter, the process advances to step 1510.

In the step 1510, the version of the map data of the in-vehicle terminal system 1300 transmitted from the terminal-side communication unit 227 in the step 1420 is received by the center-side communication unit 256. Thereafter, the process advances to step 1515.

In the step 1515, the map freshness confirmation unit 262 compares the version of the master map data acquired in the step 1505 with the version of the map data held by the in-vehicle terminal system 1300 received in the step 1510. If the version of the map data held by the in-vehicle terminal system 1300 is the same as that of the master map data (i.e., if the map data is the latest map data), the process advances to step 1520. In contrast, if the version of the map data held by the in-vehicle terminal system 1300 is older than that of the master map data (i.e., if the map data is not the latest map data), the process advances to step 1525.

In the step 1520, freshness information indicating that the map data held by the in-vehicle terminal system 1300 is the latest is transmitted from the center-side communication unit 256 to the terminal-side communication unit 227 of the in-vehicle terminal system 1300. Thereafter, the process advances to the step 1530.

In the step 1525, freshness information indicating that the map data held by the in-vehicle terminal system 1300 is old is transmitted from the center-side communication unit 256 to the terminal-side communication unit 227 of the in-vehicle terminal system 1300. Thereafter, the process advances to the step 1530.

Returning to FIG. 14, in step 1425, the freshness information transmitted from the control center system 1350 in the step 1520 (freshness information indicating that the map data held by the in-vehicle terminal system 1300 is the latest) or in the step 1525 (freshness information indicating that the map data held by the in-vehicle terminal system 1300 is old) is received by the terminal-side communication unit 227 of the in-vehicle terminal system 1300. Thereafter, the process advances to step 1430.

In the step 1430, if the freshness information received in the step 1425 indicates that the map data is the latest, the mode switching control unit 221 permits the switching to the autonomous mode and advances to step 1460. If not the latest (old map), the mode switching control unit 221 does not permit the switching to the autonomous mode. In this case, the process advances to step 1435.

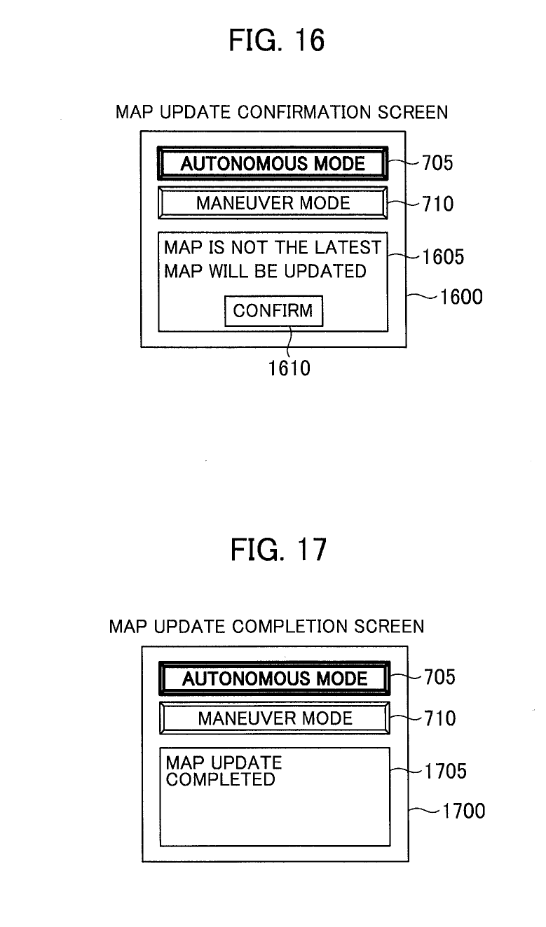

In the step 1435, a map update confirmation screen for prompting the operator to update the map is displayed on the terminal-side display unit 233. FIG. 16 is a schematic diagram showing an example of the map update confirmation screen which is displayed in the step 1435. Arranged on the map update confirmation screen 1600 in FIG. 16 are a window 1605 (displaying messages “MAP IS NOT THE LATEST” and “MAP WILL BE UPDATED” for prompting the operator to update the map) and a map update confirmation button 1610. The map update confirmation button 1610 is a button to be pressed by the operator to confirm the starting of the map update. The map update is started when the map update confirmation button 1610 is pressed by the operator.

Returning to FIG. 14, in step 1440, a map update request for requesting update data to be used for updating the map data to the latest map data is transmitted from the terminal-side communication unit 227 to the center-side communication unit 256 of the control center system 1350.

As shown in step 1530 in FIG. 15, the control center system 1350 executes a process of having the center-side communication unit 256 receive the map update request transmitted in the step 1440 from the terminal-side communication unit 227 of the in-vehicle terminal system 1300. If the map update request is received by the center-side communication unit 256, the process advances to step S1535, otherwise the process returns to the step 1505.

In the step S1535, the update data generation unit 1360 generates map update data for matching the version of the map data in the terminal map DB 218 with that of the map data in the master map DB 259. Thereafter, the process advances to step 1540. The map update data can either be all the map data managed by the master map DB 259 or data representing the difference between the map data in the master map DB 259 and the map data in the terminal map DB 218. In the former case, the map update can be performed by just overwriting all the map data in the terminal map DB 218 with the map update data. In the latter case, the map update can be performed by overwriting part of the map data in the terminal map DB 218 corresponding to the difference data (map update data) by use of the map update data.

In the step 1540, the map update data generated by the update data generation unit 1360 is transmitted from the center-side communication unit 256 to the terminal-side communication unit 227 of the in-vehicle terminal system 1300. Thereafter, the process returns to the step 1505.

Subsequently, in the in-vehicle terminal system 1300, the map update data transmitted from the control center system 1350 in the step 1540 is received by the terminal-side communication unit 227 (step 1445) as shown in FIG. 14. Thereafter, the process advances to step 1450.

In the step 1450, the map update unit 1310 updates the map data managed by the terminal map DB 218 to the latest state (identical with the state of the master map data) by using the map update data received in the step 1445. Thereafter, the process advances to step 1455.

In the step 1455, a map update completion screen is displayed on the terminal-side display unit 233. FIG. 17 is a schematic diagram showing an example of the map update completion screen displayed in the step 1455. The map update completion screen 1700 shown in FIG. 17 has a window 1705 displaying a message “MAP UPDATE COMPLETED”.

In the step 1460, the mode switching control unit 221 executes the switching process from the maneuver mode to the autonomous mode. In this switching process, the control is switched from the control by the vehicle control unit (maneuver mode) 203 (controlling the vehicle according to the operation by the operator) to the control by the vehicle control unit (autonomous mode) 206 (performing the autonomous traveling control of autonomously steering and accelerating/decelerating the vehicle according to commands from the control center system 1350). Thereafter, the process advances to the step 1465.

In the above step 1460, the aforementioned screen 800 for informing the operator of the switching to the autonomous mode (see FIG. 8) is displayed on the terminal-side display unit 233 similarly to the first embodiment. This display lets the operator recognize that the traveling mode of the mining dump truck has been switched to the autonomous mode.

In the step 1465, the terminal-side control unit 215 judges whether the maneuver mode switching request has been received or not. If received, the process advances to step 1470. If not received, the process returns to the step 1405.

In the step 1470, the mode switching control unit 221 executes the switching process from the autonomous mode to the maneuver mode. In this switching process, the control is switched from the control by the vehicle control unit (autonomous mode) 206 (performing the autonomous traveling control of autonomously steering and accelerating/decelerating the vehicle according to commands from the control center system 1350) to the control by the vehicle control unit (maneuver mode) 203 (controlling the vehicle according to the operation by the operator). Thereafter, the process returns to the step 1405.

In the above step 1470, the aforementioned screen 1000 for informing the operator of the switching to the maneuver mode (see FIG. 10) is displayed on the terminal-side display unit 233 similarly to the first embodiment. This display lets the operator recognize that the traveling mode of the mining dump truck has been switched to the maneuver mode.

According to the second embodiment configured as above, the check of the map data freshness is conducted upon receiving the autonomous mode switching request. If the map data is not the latest, the switching to the autonomous mode is carried out after updating the map. Therefore, the mining dump truck is prevented from erroneously traveling on an old carrying passage not in conformity with the latest carrying passages. This contributes to the prevention of accidents. Further, the switching from the maneuver mode to the autonomous mode can be conducted smoothly since the process for updating the map data to the latest map data is performed automatically upon the pressing of the map update confirmation button 1610 (see FIG. 16).

### Third Embodiment

Next, a third embodiment of the present invention will be described. In a navigation system for autonomous mining dump trucks according to the third embodiment, whether the version of the map data held by the mining dump truck is the latest or not is checked at the startup of the mining dump truck. If the map data is not of the latest version, the button for selecting the autonomous mode is made non-selectable (inactivated) so as to disable the transition from the maneuver mode to the autonomous mode, by which the mining dump truck is prevented from erroneously traveling on a carrying passage not in conformity with the actual carrying passages. In this case where the map data is not the latest, a screen for prompting the operator to update the map is displayed. After completing the map update, the button for selecting the autonomous mode is made selectable (activated). By enabling the transition to the autonomous mode only when the map data is the latest, the mining dump truck is prevented from erroneously traveling on a carrying passage not in conformity with the actual carrying passages.

In the third embodiment, the freshness confirmation of the map data and the acquisition of the map update data are carried out via a storage medium that is easily portable. A case where a USB flash memory is used as the storage medium will be explained below. The USB flash memory in this embodiment is assumed to have stored the latest map data supplied from the control center and containing its version information (master map data) and the map update data equivalent to the map update data generated by the update data generation unit 1360 in the second embodiment.

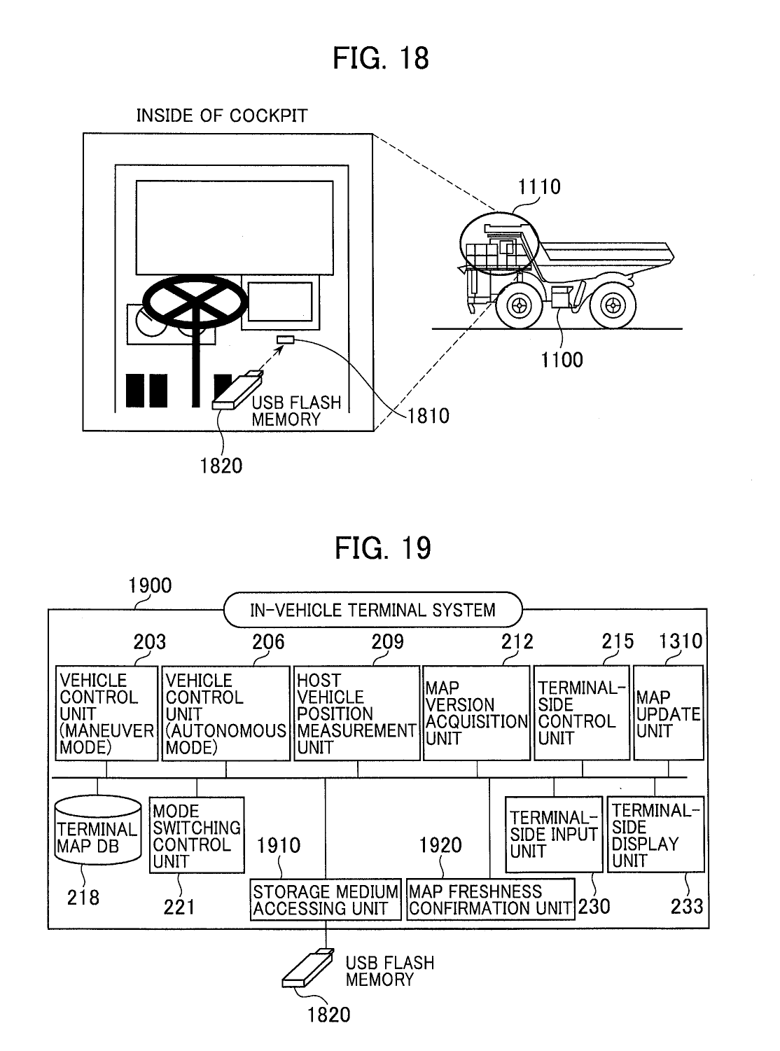

Here, how the USB flash memory for the map update in the third embodiment is used (inserted) will be explained by referring to FIG. 18. The cockpit 1110 of the mining dump truck 1100 shown in FIG. 18 is equipped with an interface (USB terminal) 1810 for acquiring data from the USB flash memory 1820. By inserting the USB flash memory 1820 into the interface 1810, the map update data and the version information on the latest map data can be loaded into the in-vehicle terminal system of the mining dump truck 1100.

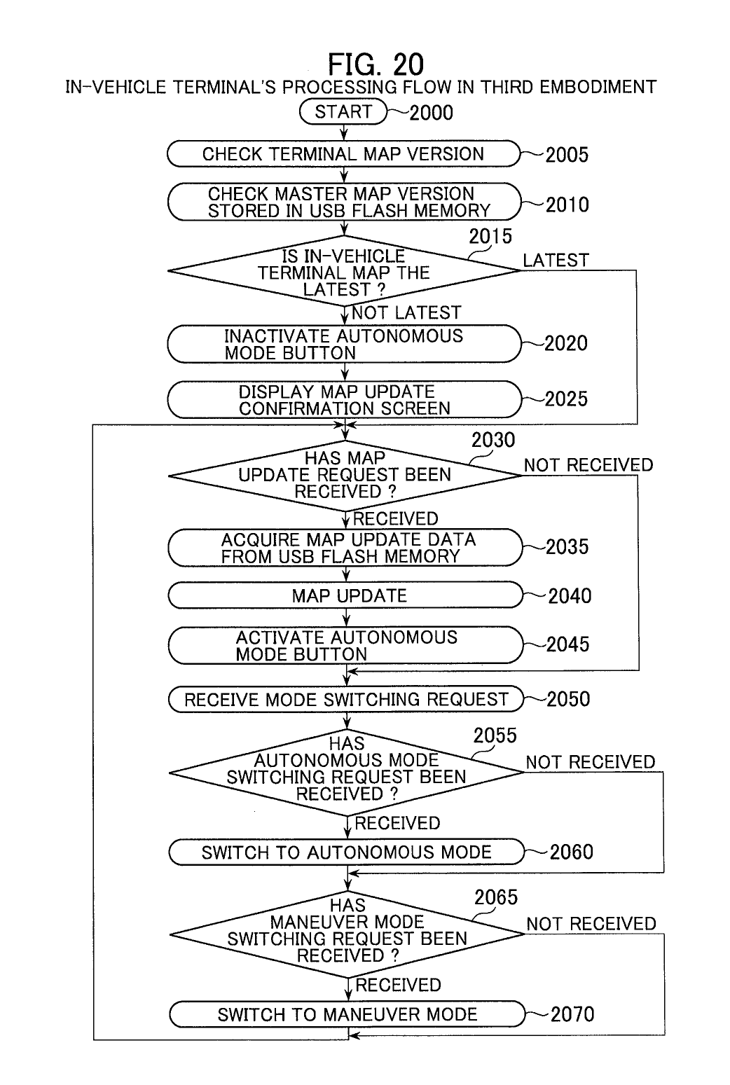

FIG. 19 is a block diagram showing a system configuration employed in the third embodiment of the present invention. The autonomous traveling system shown in FIG. 19 comprises an in-vehicle terminal system 1900 which is installed in the mining dump truck 1100. The in-vehicle terminal system 1900 corresponds to a system implemented by leaving out the terminal-side communication unit 227 from the in-vehicle terminal system 1300 in the second embodiment and adding a storage medium accessing unit 1910 and a map freshness confirmation unit 1920 to the in-vehicle terminal system 1300. Components in FIG. 19 equivalent to those in FIG. 3 or 13 are assigned the already used reference characters and repeated explanation thereof is omitted properly.

The storage medium accessing unit 1910 is a part for acquiring the map update data and the version information on the latest map data from the USB flash memory 1820 inserted into the interface 1810 shown in FIG. 18. The map freshness confirmation unit 1920 is a part for confirming whether the map data held by the terminal map DB 218 is the latest or not by comparing the version of the map data with the version of the latest map data stored in the USB flash memory 1820.

FIG. 20 is a flow chart of a process executed by the in-vehicle terminal system 1900 according to the third embodiment.

First, the in-vehicle terminal system 1900 executes the initial setting process (receiving the processing start request from a user, checking whether the mining dump truck's engine is ON or not, and so forth) in step 2000. The processing start request from the user is inputted via the terminal-side input unit 230.

In step 2005, the map version acquisition unit 212 acquires the version information on the map data managed by the terminal map DB 218. Thereafter, the process advances to step 2010.

In the step 2010, the storage medium accessing unit 1910 acquires the version information on the latest map data stored in the USB flash memory 1820. Thereafter, the process advances to step 2015.

In the step 2015, the map freshness confirmation unit 1920 compares the version information on the latest map data acquired in the step 2010 with the version information on the map data managed by the terminal map DB 218 acquired in the step 2005. If the version of the map data managed by the terminal map DB 218 is the same as that of the master map data (latest map data) (i.e., if the map data is the latest map data), the process advances to step 2030. In contrast, if the version of the map data managed by the terminal map DB 218 is older than that of the latest map data, the process advances to step 2020.

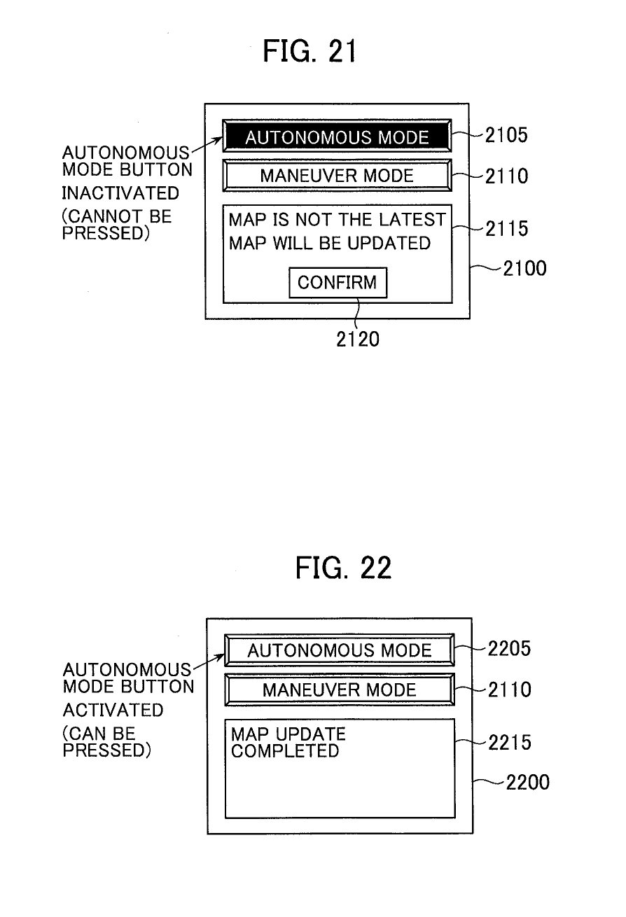

In the step 2020, the mode switching control unit 221 inactivates the autonomous mode button (explained later) on the map update confirmation screen displayed on the terminal-side display unit 233. In the next step 2025, the map update confirmation screen with the inactivated autonomous mode button is displayed on the terminal-side display unit 233. FIG. 21 is a schematic diagram showing an example of the map update confirmation screen displayed in the step 2025.

Arranged on the map update confirmation screen 2100 in FIG. 21 are an autonomous mode button 2105 which has been inactivated to prohibit the operator from pressing it, a maneuver mode button 2110, a window 2115 displaying messages “MAP IS NOT THE LATEST” and “MAP WILL BE UPDATED”, and a map update confirmation button 2120. In this example, for easy discrimination between the active state and the inactive state of the autonomous mode button, a solid black button 2105 (see FIG. 21) is displayed when the button is inactive and a solid white button 2205 (see FIG. 22) is displayed when the button is active. As shown in FIG. 21, the selection of the autonomous mode through the terminal-side display unit 233 becomes impossible when the version of the map data managed by the terminal map DB 218 is older than that of the latest map data. The map update confirmation button 2120 is a button to be pressed by the operator in the step 2025 to confirm the starting of the map update. The map update is started when the map update confirmation button 2120 is pressed by the operator.

In the step 2030, if the pressing of the map update confirmation button 2120 on the screen 2100 in FIG. 21 is detected by the terminal-side input unit 230 (i.e., if the map update request has been received), the process advances to step 2035. If the map update confirmation button 2120 has not been pressed (i.e., if no map update request has been received), the process advances to step 2050.

In the step 2035, the storage medium accessing unit 1910 acquires the map update data stored in the USB flash memory 1820. Thereafter, the process advances to step 2040.

In the step 2040, the map update unit 1310 updates the map data in the terminal map DB 218 by using the map update data acquired in the step 2035. Thereafter, the process advances to step 2045.

In the step 2045, the mode switching control unit 221 activates the autonomous mode button and displays the map update completion screen including the activated autonomous mode button on the terminal-side display unit 233. FIG. 22 is a schematic diagram showing an example of the map update completion screen displayed in the step 2045. Arranged on the map update completion screen 2200 in FIG. 22 are an autonomous mode button 2205 which has been activated to allow the operator to press it, the maneuver mode button 2110, and a window 2215 displaying a message “MAP UPDATE COMPLETED”. After displaying the map update completion screen (step 2045), the process advances to the step 2050.

In the step 2050, the autonomous mode switching request or the maneuver mode switching request from the operator is received by the terminal-side input unit 230. Thereafter, the process advances to step 2055. The mode switching request from the operator is received by use of the screen 700 shown in FIG. 7 similarly to the first embodiment.

In the step 2055, the terminal-side control unit 215 judges whether the autonomous mode switching request has been received in the step 2050 or not. If received, the process advances to step 2060. If not received, the process advances to step 2065.

In the step 2060, the mode switching control unit 221 executes the switching process from the maneuver mode to the autonomous mode. In this switching process, the control is switched from the control by the vehicle control unit (maneuver mode) 203 (controlling the vehicle according to the operation by the operator) to the control by the vehicle control unit (autonomous mode) 206 (performing the autonomous traveling control of autonomously steering and accelerating/decelerating the vehicle according to commands from the control center system (unshown)). Thereafter, the process advances to the step 2065.

In the above step 2060, the aforementioned screen 800 for informing the operator of the switching to the autonomous mode (see FIG. 8) is displayed on the terminal-side display unit 233 similarly to the first embodiment. This display lets the operator recognize that the traveling mode of the mining dump truck has been switched to the autonomous mode.

In the step 2065, the terminal-side control unit 215 judges whether the maneuver mode switching request has been received in the step 2050 or not. If received, the process advances to step 2070. If not received, the process returns to the step 2030.

In the step 2070, the mode switching control unit 221 executes the switching process from the autonomous mode to the maneuver mode. In this switching process, the control is switched from the control by the vehicle control unit (autonomous mode) 206 (performing the autonomous traveling control of autonomously steering and accelerating/decelerating the vehicle according to commands from the control center system (unshown)) to the control by the vehicle control unit (maneuver mode) 203 (controlling the vehicle according to the operation by the operator). Thereafter, the process returns to the step 2030.

In the above step 2070, the aforementioned screen 1000 for informing the operator of the switching to the maneuver mode (see FIG. 10) is displayed on the terminal-side display unit 233 similarly to the first embodiment. This display lets the operator recognize that the traveling mode of the mining dump truck has been switched to the maneuver mode.

Incidentally, while an example of confirming the map freshness and acquiring the map update data via the USB flash memory 1820 has been described in the above third embodiment, other types of external storage media (CD, DVD, etc.) may also be used. It is also possible to acquire the data for the map freshness confirmation and the map update data from the control center system (250, 1350) similarly to the first and second embodiments. In this case, the control center system (250, 1350) may periodically distribute the latest map data and the in-vehicle terminal system may make the judgment on the map update based on the latest map data received from the control center system, for example.

According to the third embodiment configured as above, when the map data held by the mining dump truck is not the latest, the button for selecting the autonomous mode is inactivated and the transition to the autonomous mode is prohibited. Therefore, the mining dump truck is prevented from erroneously traveling on an old carrying passage not in conformity with the latest carrying passages. This contributes to the prevention of accidents. Further, the button for selecting the autonomous mode can be activated again smoothly since the process for updating the map data to the latest map data is performed automatically upon the pressing of the map update confirmation button 2120 displayed on the map update confirmation screen 2100 (see FIG. 21). Furthermore, thanks to the map freshness confirmation and the map data update by use of a storage medium (e.g., USB flash memory), the mining dump truck is prevented from erroneously traveling on an old carrying passage not in conformity with the latest carrying passages even in an environment having no wireless connection with the control center system.

While the transition to the autonomous mode according to the operator's request is prohibited by inactivating the autonomous mode selection button (autonomous mode button) in the above embodiment in the case where the map data is not the latest, it is also possible in this case to erase the autonomous mode selection button from the screen or to prohibit the transition to the autonomous mode even if the button on the screen is pressed.

### Fourth Embodiment

Next, a fourth embodiment of the present invention will be described. In a navigation system for autonomous mining dump trucks according to the fourth embodiment, the in-vehicle terminal system periodically (at certain intervals) refers to the control center on whether the map data held by the mining dump truck in which the autonomous mode has been selected is of the latest version or not. If the map data is not the latest, the traveling mode is forcibly switched from the autonomous mode to the maneuver mode. With the configuration of the fourth embodiment, when the map data held by the mining dump truck is not the latest, the traveling mode is automatically switched from the autonomous mode to the maneuver mode and the mining dump truck is prevented from erroneously traveling on an old carrying passage not in conformity with the latest carrying passages.

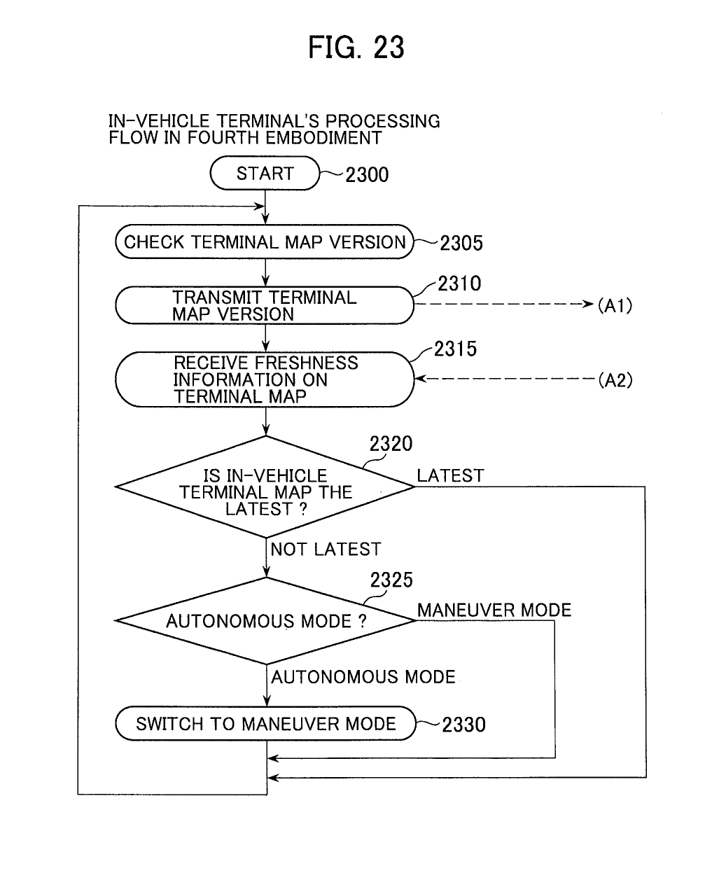

The autonomous traveling system according to the fourth embodiment comprises an in-vehicle terminal system 200 and a control center system 250 basically equivalent to those in the first embodiment, and thus the explanation of the system configuration is omitted here. FIG. 23 is a flow chart of a process executed by the in-vehicle terminal system 200 according to the fourth embodiment. Incidentally, the processing flow of the control center system 250 in the fourth embodiment is equivalent to that in the first embodiment (FIG. 5).

Referring to FIG. 23, the in-vehicle terminal system 200 first executes the initial setting process (receiving the processing start request from a user, checking whether the mining dump truck's engine is ON or not, and so forth) in step 2300. When the processing start request from the user is inputted via the terminal-side input unit 230, the process advances to step 2305.

In the step 2305, the map version acquisition unit 212 acquires the version of the map data managed by the terminal map DB 218. Thereafter, the process advances to step 2310. The step 2305 is executed at certain intervals. The interval of execution of the step 2305 can be changed as needed. By using the acquired version, a process of referring to the control center on whether the map data held by the mining dump truck is of the latest version or not (explained later) is executed at certain intervals.

In the step 2310, the version of the map data in the in-vehicle terminal system 200 acquired by the map version acquisition unit 212 in the step 2305 is transmitted to the center-side communication unit 256 of the control center system 250 via the terminal-side communication unit 227.

As shown in FIG. 5, the control center system 250 executes the initial setting process (e.g., receiving the processing start request from a user) in step 500 and then advances to step 505. The processing start request from the user is inputted via the center-side input unit 265.

In the step 505, the map freshness confirmation unit 262 acquires the version of the master map data managed by the master map DB 259 (i.e., the version of the latest map data). Thereafter, the process advances to step 510.

In the step 510, the map data version transmitted from the terminal-side communication unit 227 of the in-vehicle terminal system 200 in the step 410 is received by the center-side communication unit 256. Thereafter, the process advances to step 515.

In the step 515, the map freshness confirmation unit 262 compares the version of the master map data acquired in the step 505 with the version of the map data held by the in-vehicle terminal system 200 received in the step 510. If the version of the map data held by the in-vehicle terminal system 200 is the same as that of the master map data (i.e., if the map data is the latest map data), the process advances to step 520. In contrast, if the version of the map data held by the in-vehicle terminal system 200 is older than that of the master map data (i.e., if the map data is not the latest map data), the process advances to step 525.

In the step 520, the freshness information indicating that the map data held by the in-vehicle terminal system 200 is the latest is transmitted from the center-side communication unit 256 to the terminal-side communication unit 227 of the in-vehicle terminal system 200. Thereafter, the process returns to the step 505.

In the step 525, the freshness information indicating that the map data held by the in-vehicle terminal system 200 is old is transmitted from the center-side communication unit 256 to the terminal-side communication unit 227 of the in-vehicle terminal system 200. Thereafter, the process returns to the step 505.

Returning to FIG. 23, in step 2315, the freshness information transmitted from the control center system 250 in the step 520 (freshness information indicating that the map data held by the in-vehicle terminal system 200 is the latest) or in the step 525 (freshness information indicating that the map data held by the in-vehicle terminal system 200 is old) is received by the terminal-side communication unit 227 of the in-vehicle terminal system 200. Thereafter, the process advances to step 2320.

In the step 2320, the mode switching control unit 221 checks whether the freshness information received in the step 2315 indicates that the map data held by the in-vehicle terminal system 200 is the latest or not. If the map data is the latest, the process returns to the step 2305. If the map data is not the latest (old map), the process advances to step 2325.

In the step 2325, the terminal-side control unit 215 checks which of the autonomous mode and the maneuver mode has been selected in the mining dump truck. If the autonomous mode has been selected, the process advances to step 2330. If the maneuver mode has been selected, the process returns to the step 2305.

In the step 2330, the mode switching control unit 221 forcibly executes the switching process from the autonomous mode to the maneuver mode. In this switching process, the control is switched from the control by the vehicle control unit (autonomous mode) 206 (performing the autonomous traveling control of autonomously steering and accelerating/decelerating the vehicle according to commands from the control center system 250) to the control by the vehicle control unit (maneuver mode) 203 (controlling the vehicle according to the operation by the operator). Thereafter, the process returns to the step 2305.

In the above step 2330, the screen 1000 for informing the operator of the switching to the maneuver mode (see FIG. 10) is displayed on the terminal-side display unit 233. Specifically, the message “SWITCHED TO MANEUVER MODE” is displayed in the mode switching information window 1015 of the screen 1000. This display lets the operator recognize that the traveling mode of the mining dump truck has been switched to the maneuver mode.

According to the fourth embodiment configured as above, whether the map data held by the mining dump truck in which the autonomous mode has been selected is of the latest version or not is checked by the control center at certain intervals and the traveling mode of the mining dump truck is automatically switched from the autonomous mode to the maneuver mode when the map data is not the latest. Consequently, the mining dump truck is prevented from erroneously traveling on an old carrying passage not in conformity with the latest carrying passages. This contributes to the prevention of accidents.

While the traveling mode of the mining dump truck in which the autonomous mode has been selected is automatically switched to the maneuver mode in the fourth embodiment when the map data of the mining dump truck in the autonomous mode is confirmed to be old, it is also possible to check whether the map data of the mining dump truck in which the maneuver mode has been selected is the latest or not at certain intervals and automatically execute a process of prohibiting the switching to the autonomous mode when the map data is confirmed to be old. Further, the map update unit 1310 may be added to the autonomous traveling system of the fourth embodiment. In this case, similarly to the second and third embodiments, the process for letting the operator confirm the execution of the update to the latest map data may be performed by the map update unit 1310 when the map data is confirmed to be old.

Incidentally, while the components constituting the autonomous traveling system are properly divided and arranged in two systems (the mining dump truck and the control center) in the above embodiments, the arrangement of the components is not restricted to the examples described in the embodiments. For example, the components of the autonomous traveling system may also be divided and arranged in three or more systems.

While the autonomous traveling of a mining dump truck (dump truck) has been described in the above embodiments, the present invention is applicable also to autonomous traveling of other types of work machines (hydraulic excavator, wheel loader, etc.).

The present invention is not restricted to the above-described embodiments but contains a variety of modified examples within the scope not departing from the subject matter of the invention. For example, the present invention is not restricted to autonomous traveling systems comprising all the configuration described in each of the above embodiments but contains autonomous traveling systems lacking part of the configuration. It is also possible to add part of the configuration of an embodiment to the configuration of another embodiment, or to replace part of the configuration of an embodiment with part of the configuration of another embodiment. For example, the information for the map freshness confirmation, the map update data, etc. may be acquired by the in-vehicle terminal system by use of an external storage medium (e.g., USB flash memory) in the first and second embodiments. In this case, the switching from the autonomous mode to the maneuver mode is conducted when the version of the map data in the in-vehicle terminal is older than the version of the map data in the external storage medium (e.g., USB flash memory).

The configuration of each autonomous traveling system, the functions of the configuration, and the processes executed by the configuration, etc. may also be partially or totally implemented by hardware (e.g., by designing logics for executing various functions in the form of an integrated circuit). Further, the configuration of the control unit may be implemented by a program (software) that is loaded and executed by a processing unit (e.g., CPU) to realize the functions of the configuration of the control unit. Information describing the program can be stored in a semiconductor memory (flash memory, SSD, etc.), a magnetic storage device (e.g., hard disk drive) or a storage medium (magnetic disc, optical disc, etc.), for example.

Further note that, in the embodiments described above, the control lines and information lines shown above represent only those lines construed as necessary to illustrate the present embodiments, not necessarily representing all the lines required in terms of products. It should be understood that in actuality substantially whole configurations are interconnected.

What is claimed is:

1. A navigation system for autonomous dump trucks comprising:
a dump truck which is capable of traveling autonomously based on map data created by digitizing a map of roads on which the dump truck can travel; and
a control unit which executes switching control between an autonomous mode to be selected when the autonomous traveling of the dump truck should be performed and a different mode to be selected when the autonomous traveling of the dump truck should be interrupted, based on version information on the map data used by the dump truck for the autonomous traveling and version information on master map data created by digitizing a map of the latest roads on which the dump truck can travel.

2. The navigation system for autonomous dump trucks according to claim 1, wherein the control unit permits the switching from the different mode to the autonomous mode only when the version information on the map data coincides with the version information on the master map data.

3. The navigation system for autonomous dump trucks according to claim 1, wherein the control unit checks the version information on the map data and the version information on the master map data at the startup of the autonomous traveling system and permits the switching to the autonomous mode only when the version information on the map data coincides with the version information on the master map data.

4. The navigation system for autonomous dump trucks according to claim 1, wherein the control unit carries out switching from the autonomous mode to the different mode when the autonomous mode has been selected and the version information on the map data does not coincide with the version information on the master map data.

5. The navigation system for autonomous dump trucks according to claim 1, further comprising an input unit through which an operator makes the selection of the autonomous mode or the different mode,
wherein the control unit disables the selection of the autonomous mode through the input unit when the version information on the map data does not coincide with the version information on the master map data.

6. The navigation system for autonomous dump trucks according to claim 1, further comprising a map update unit which updates the map data to the latest map data when the version information on the map data does not coincide with the version information on the master map data.
